(19) United States
(12) Patent Application Publication
(10) Pub. No.: US 2011/0067257 A1
(43) Pub. Date: Mar. 24, 2011

(54) YANKEE DRYER HAVING CENTRIFUGALLY ASSISTED CONDENSATE COLLECTION

(76) Inventor: Richard Fearnside, Brodhead, WI (US)

(21) Appl. No.: 12/563,926

(22) Filed: Sep. 21, 2009

(51) Int. Cl. F26B 17/30; D06F 58/04; F26B 13/00; B23P 19/04

(52) U.S. Cl. 34/58; 34/110; 34/618; 29/700

(57) ABSTRACT

A Yankee dryer which exploits centrifugal forces to assist in evacuating condensate. A condensate collection system has individual pickup straws arranged at an angle such that the required amount of motive steam pressure is reduced to extract and move the steam condensate from the intake opening of the straw to the discharge point of that straw. The pickup straws communicate with a collection header arranged along the length of the Yankee dryer. The collection header is configured such that it has a radius from the axis of rotation which is greatest near the point at which collected condensate is discharged to a disposal riser conduit which conducts collected condensate to the exterior of the Yankee dryer.

### FIELD OF THE INVENTION

The present invention pertains to Yankee dryers and more particularly to a Yankee dryer having a system of condensate collection and disposal which utilizes centrifugal force from operation of the Yankee dryer.

### BACKGROUND OF THE INVENTION

A Yankee dryer essentially comprises a large generally cylindrical drum which is internally heated by pressurized steam to dry a paper web on its outside shell surface. The thermal gradients through the pressure containing components, specifically the shell of the cylinder, cause condensate to form on the inside surface of this shell, which must be evacuated for efficient heat transfer in drying the paper web. As the Yankee dryers rotate at high speeds, this condensate is physically forced to the shell inside surface and typically removed using a condensate removal system.

Removal of condensate requires a differential motive pressure from the source to the evacuation point or points to force the condensate into the condensate removal system through a pickup device, usually designated for ribbed bore shells as straws. Once the condensate is in the straw, typical condensate removal systems rely substantially on this differential motive pressure to force the steam through the straws into a condensate header. Once in the header, the differential motive pressure must force the condensate through the condensate header to an additional evacuation point, typically named a riser pipe, which is then pulled or suctioned to the center of the drum for evacuation to the external environment of the Yankee dryer through one of the supporting ends of the drum.

Manufacturers of Yankee dryers have necessarily used the centrifugal forces due to rotation of the drum to pool or isolate the condensate to the bore of a plain bore shell, or to the grooves of a Yankee dryer having a ribbed bore. No specific condensate system has been configured to reduce the amount of differential motive steam required to remove the condensate using the centrifugal forces due to rotation by geometrically using the intrinsic mechanical advantage of these forces.

Since, for conventional condensate systems, the differential motive pressure is the only significant application of force to cause the condensate to flow efficiently through the condensate removal system, there exist a need to exploit these intrinsic forces to reduce energy consumption and thus enhance efficiency of the condensate removal system as a whole.

### SUMMARY OF THE INVENTION

The present invention provides a way to exploit centrifugal forces to assist in evacuating condensate from rotating Yankee dryers. The collection apparatus is arranged to cause condensate to flow from a condition dispersed along the length of the cylindrical drum to a central collection point for example under the influence of centrifugal forces. This is accomplished by arranging collection conduits such as individual liquid pickup straws and a collection header into which the pickup straws discharge collected condensate each to have liquid pick up points that are at a lesser radial distance from the axis of rotation than the discharge ends. The collection header terminate may have a central location within the cylindrical drum near the outer surface thereof. A disposal riser conduit may take in collected condensate from the collection header at the central location. Liquids are thus collected from along the length of the drum and delivered with the assistance of centrifugal forces to the central location, where they may enter the disposal riser conduit. Pressure from steam used to dry the unfinished materials for example may provide the motive power to force the collected condensate within the disposal riser conduit towards the axis of rotation and ultimately to the exterior of the cylindrical drum.

The operative premise of the present invention is that centrifugal forces are exploited to deliver condensate laterally from along the length of the cylindrical drum to one or more collection points for disposal. There is no ineffectual effort to utilize centrifugal forces to force collected condensate towards the axis of rotation, which flow would be opposed rather than assisted by centrifugal forces.

The novel collection apparatus and associated pickup straws may be furnished as a modular unit for installing into new Yankee dryers and for retrofitting existing Yankee dryers. The modular units may be fabricated in one size or capacity, so that an appropriate number of modules may be installed into any given Yankee dryer. Thus a production run of one model or size or capacity of modules may serve all or almost all of the Yankee dryers in use or contemplated for use in the paper industry.

### BRIEF DESCRIPTION OF THE DRAWINGS

Similar reference characters denote corresponding features consistently throughout the attached drawings.

FIG. 1 is a diagrammatic perspective view of a Yankee dryer incorporating a condensate evacuation system according to at least one aspect of the invention, the Yankee dryer being partly broken away to reveal internal detail.

FIG. 2 is an end view of the interior of the Yankee dryer of FIG. 1.

FIG. 3 is a cross sectional view of the Yankee dryer of FIG. 1.

FIG. 4 is an end view of the interior of another Yankee dryer according to a further aspect of the invention.

FIG. 5 is a side detail view of the center of FIG. 4.

FIG. 6 is a block diagram summarizing steps of a method according to a sill further aspect of the invention.

### DETAILED DESCRIPTION

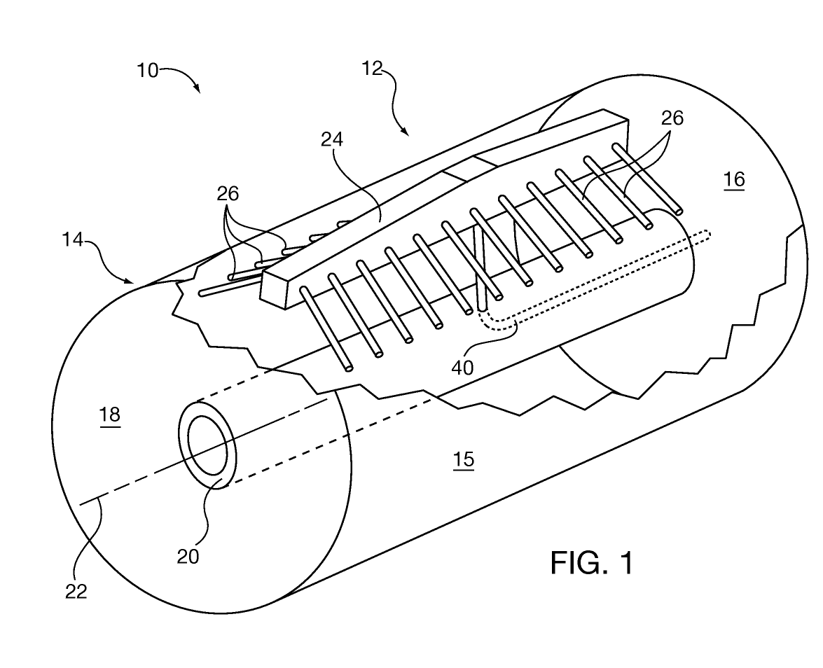

FIG. 1 shows an improved Yankee dryer 10 having a centrifugally assisted condensate disposal system 12 incorporated thereinto. The Yankee dryer 10 comprises a cylindrical drum 14 comprising a circumferential wall 15, a first end wall 16, a second end wall 18, and a mainstay 20 disposed to position the cylindrical drum 14 relative to an environmental support (not shown). An axis of rotation 22 extends along the length of the cylindrical drum 14 and is generally horizontal when the Yankee dryer 10 is mounted in the usual position for use in drying unfinished raw material for paper making. Because Yankee dryers are conventional, not all of the structural features of the improved Yankee dryer 10 will be shown. For example, mounting structure for mounting the Yankee dryer 10 suitably within its operating environment, a drive system for rotating the Yankee dryer 10 about the axis of rotation 22, and a steam supply system for drying the unfinished raw material all are omitted for clarity of the view.

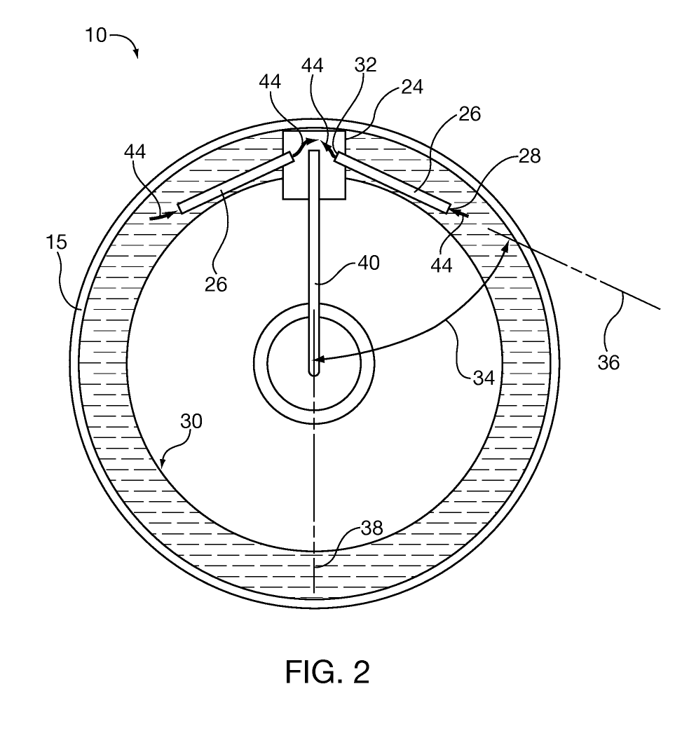

Conventional Yankee dryers have condensate disposal systems which include components which are similar to those of the improved Yankee dryer 10, but which components are not arranged according to the inventive concept. For purposes of general review and understanding, the condensate disposal system 12 comprises one or more liquid collection units each comprising a collection header 24 and a plurality of pickup straws 26 which project laterally from the collection header 24. The collection header 24 is a hollow conduit disposed in fluid communication with each pickup straw 26. Each pickup straw 26 comprises a pickup opening 28 which opens to the interior of the cylindrical drum 14 to take in condensate 30 (see FIG. 2) and a discharge opening 32 which opens to the interior of the collection header 24.

Flow of condensate 30 through the condensate disposal system 12 is illustrated in FIG. 2. The collection header 24 is mounted very close to or as depicted, abutting the circumferential wall 15 of the cylindrical drum 14. Each pickup straw 26 may project laterally from the collection header 24 such that an included angle 34 formed between the center line 36 of each pickup straw 26 and the center line 38 of a disposal riser pipe or disposal riser conduit 40 is an acute angle having a magnitude lying within a range of about eighty degrees to about ninety degrees. The disposal riser conduit 40 is disposed in fluid communication with the collection header 24 and is arranged to extend to the axis of rotation 22, and along the axis of rotation 22 to the first end wall 16 and from the first end wall 16 to the exterior of the cylindrical drum 14. This is shown in FIG. 1. Discharged condensate 30 may be disposed of or reused in any suitable way.

The pickup straws 26 are arranged such that their pickup openings 28 are still conventionally located in specific points of the condensate film or pools. The differential motive steam pressure is critically used to urge this condensate into the pickup openings 28 of the individual straws 26 located in the groove bottoms of the ribbed bore of the drum 14 of the Yankee dryer 10. As employed herein, radial distances will be understood to refer to distances extending in directions radiating from the axis of rotation 22. Alternatively stated, the pickup opening 28 of each one of the pickup straws 26 is located at a first radius or radial distance from the axis of rotation, and the discharge opening 32 of the pickup straw 26 is located at a second radius or radial distance from the axis of rotation 22. The length of an individual straw 26 dictates the rate of velocity change required by the differential motive steam which must be overcome to move the condensate 30 from the pickup opening 28 to the discharge opening 32 along the length of the straw 26. The shorter the length of the straw 26, the higher the rate of velocity reduction must be to move the condensate 30 from the pickup opening 28 to the discharge opening 32. Increasing the length of each pickup straw 26 reduces the amount of differential motive steam pressure required to move the condensate 30 from the pickup opening 28 to the discharge opening 32. The flow of condensate 30 is indicated by arrows 44. This causes the condensate 30 to flow to a more central point such as the intake openings 54 of the disposal riser conduit 40. Hence, in one aspect of the invention, collection of condensate 30 is accomplished using less differential motive steam pressure than in existing conventional condensate removal systems (not shown).

The collection header 24 may be arranged so that it extends along its length in a direction essentially parallel to the axis of rotation 22. The pickup straws 26 may extend essentially perpendicularly to the length of the collection header 24.

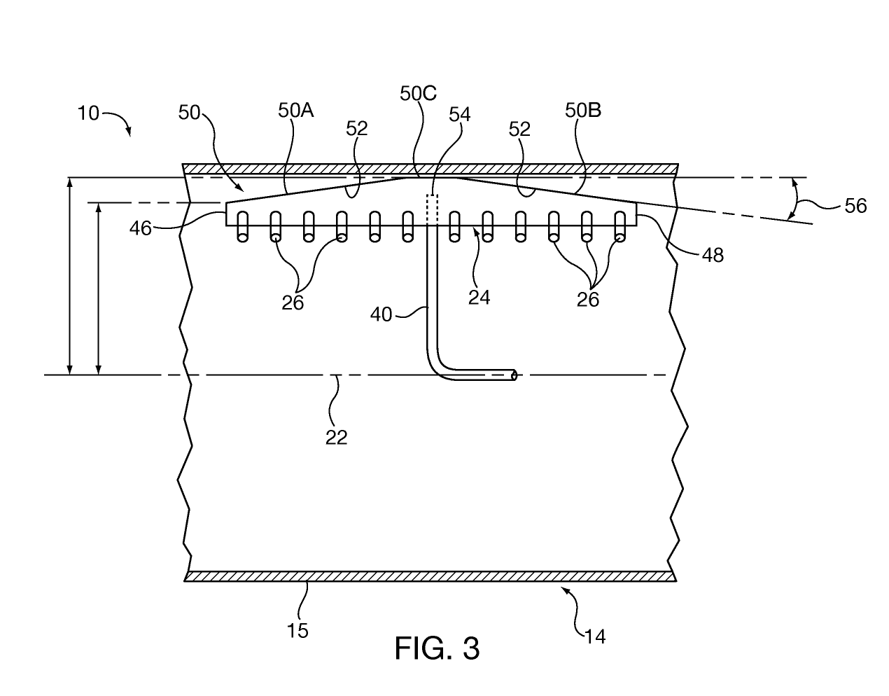

Turning now to FIG. 3, the collection header 24 has opposed ends 46 and 48. The outer wall 50 of the collection header 50, which is that facing the circumferential wall 15, inclines continuously along most of its length (where the length is parallel or relative to the axis of rotation 22) such that the radial distance from the axis of rotation 22 to the inner surface 52 of the outer wall 50 of the collection header 24 is greatest at the location of the pickup opening 54 of the disposal riser conduit 40 and is smallest at the opposed ends 46, 48 of the collection header 24.

The pickup opening 54 of the disposal riser conduit 40 is disposed in fluid communication with the collection header 24, so as to draw collected condensate 30 from the collection header for ultimate disposal to the exterior of the Yankee dryer 10.

Alternatively stated, outer wall 50 of the collection header 24 and the circumferential wall 15 of the cylindrical drum 14 each have length which is oriented parallel to the length of the other. The outer wall 50 of the collection header 24 and the circumferential wall 15 of the cylindrical drum 14 form an included angle 56 therebetween (the included angle 56 is taken along the respective lengths of the collection header 24 and of the circumferential wall 15). The included angle is between 0.1 degree and about ten degrees.

This causes condensate 30 (see FIG. 2) to flow towards the pickup opening 54 from locations distant therefrom under the influence of centrifugal forces arising from rotation of the cylindrical drum.

Of course, inclination of the outer wall 50 may incline in two directions. As shown, the outer wall may have a first inclined section 50A and an oppositely inclined section 50B. Also, the outer wall 50 may have a neutral zone 50C which extends along a perceptible if minimal distance along a direction parallel to the axis of rotation 22. This limited neutral zone 50C is not great enough to disrupt flow of condensate 30 due to centrifugal forces towards the pickup opening 54.

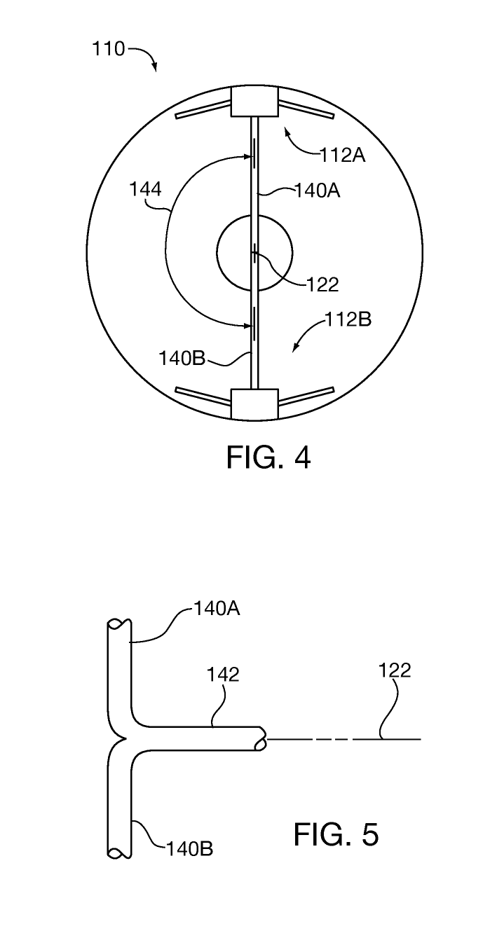

It will be appreciated that FIGS. 1, 2, and 3 are diagrammatic and not literal in nature. In practice, the condensate disposal system of a Yankee dryer such as the condensate disposal system 12 of the Yankee dryer 10 will comprise at least two condensate disposal systems 12. This is illustrated in FIG. 4 wherein a Yankee dryer 110 may have two condensate disposal systems 112A, 112B are shown. Each condensate disposal system 112A or 112B has a respective disposal riser conduit 140A or 140B. The disposal riser conduits 140A, 140B may join at the axis of rotation 122 to form a singular or common disposal conduit 142 as shown in FIG. 5. The common disposal pipe 142 may extend along the rotational axis 122 of the Yankee dryer 110 and extend to the exterior thereof.

The two condensate disposal systems 112A, 112B may be offset from one another by an angle 144 of one hundred eighty degrees with respect to the axis of rotation 122.

In respects other than those of the plural condensate disposal systems 112A, 112B, the Yankee dryer 110 may be generally similar in structure and function as the Yankee dryer 10 of FIG. 1.

A Yankee dryer may have three condensate disposal systems such as the condensate disposal systems 112A, 112B, offset from one another by angles of one hundred twenty degrees. Angular offset or spacing about an axis of rotation such as the axis of rotation 122 may be equal to three hundred sixty degrees divided by the number of condensate disposal systems actually installed. This number may be two, three, four, five or even more as desired.

Condensate disposal systems such as the condensate disposal systems 112A, 112B may be arranged not only at the same point along the length or rotational axis of their associated Yankee dryer, but may be provided in plural tiers each comprising two or more angularly offset condensate disposal systems. Each tier may be regarded as two or more condensate disposal systems which is axially spaced apart from another tier or plurality of condensate disposal systems such as the condensate disposal systems 112A, 112B.

The apparatus of a novel condensate disposal system such as the condensate disposal system 12 which includes the collection header 24 and the pickup straws 26 may be provided as a single prefabricated module which is installable within an otherwise conventional Yankee dryer. The pickup straws 26 may be permanently fixed to the collection header 24 to become a module. Modules may include an opening for receiving a disposal riser conduit such as the disposal riser conduit 40 of FIG. 1, or may have a short pipe nipple extending from the collection header of the module, such as the collection header 24, so that a disposal riser conduit may be readily joined to the module outside the collection header.

The module may comprise brackets, attachment tabs, spacers, adapters or other structure for attaching a module in place within a Yankee dryer and to enable a particular module to be compatible with Yankee dryers of different makes, models, dimensions, and configurations.

Use of condensate disposal systems in modular form enables for example Yankee dryers of different throughput rates to be accommodated by installation of different numbers of condensate disposal system modules. Identical modules may be installed in different numbers depending upon the condensate rejection rate of different Yankee dryers, thereby enabling diverse models of Yankee dryers to be served by one model or configuration of modules. For example, a Yankee dryer may be provided with two modules spaced one hundred eighty degrees apart with respect to the axis of rotation, with three modules spaced one hundred twenty degrees apart with respect to the axis of rotation, or with four modules spaced ninety degrees apart with respect to the axis of rotation. Modules may also be positioned in tiers. For example, a first tier located near a first end wall may include three modules, with a second tier located near a second end wall of the same Yankee dryer including an additional three modules. Total condensate disposal capacity may thus be provided in increments corresponding to the number of identical condensate removal modules installed in the Yankee dryer. Although Yankee dryers differ within limits as to capacity and throughput, they are fabricated within a limited range of dimensions. Therefore, only one model or design of a module may be required to serve Yankee dryers actually in production or use.

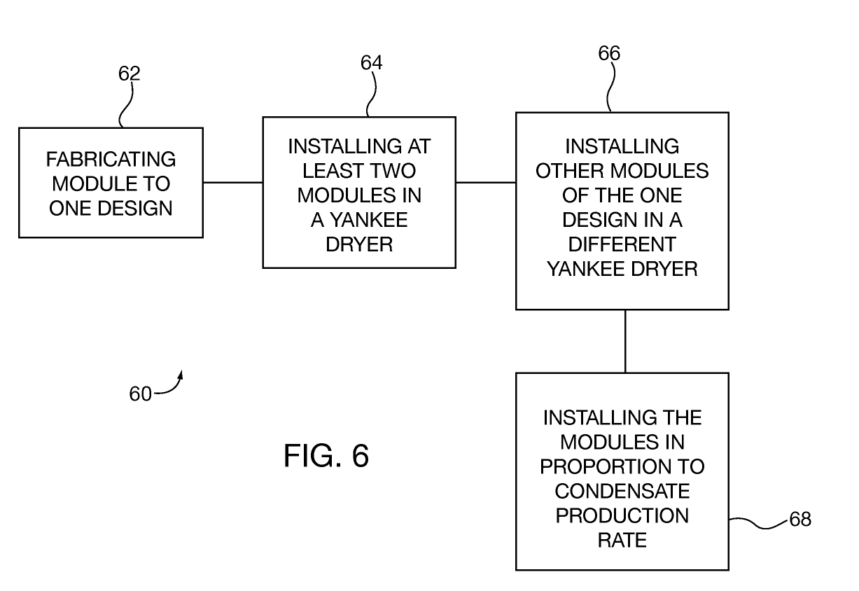

According to a further aspect then, the invention may be regarded as a method 60 of equipping different types or models of Yankee dryers. Steps of this method 60 are shown in FIG. 6. The method 60 may comprise a step 62 of fabricating condensate disposal system modules to only one design, wherein one design signifies that each condensate disposal module is essentially identical to others being fabricated; a step 64 of installing at least two of the identical condensate disposal system modules in a particular Yankee dryer; a step 66 of installing other ones of the identical condensate disposal system modules in a different Yankee dryer; and a step 68 of installing identical condensate disposal system modules in any one Yankee dryer in proportion to the condensate production rate of the one Yankee dryer.

The term central location, as applied to the point within a cylindrical drum such as the cylindrical drum 14 from which a discharge conduit such as the disposal riser conduit 40 collects condensate is not intended to imply a location that is centered within the cylindrical drum. Rather, the term is intended to connote a singular pickup point for condensed liquids dispersed widely outside that pickup point.

Description of the outer wall of a collection header such as the collection header 24 as continuously inclining does not necessarily imply that the slope of the outer wall is identical at all points along the length of the outer wall of the collection header.

While the invention has been presented in terms of a single collection point for collecting condensate, it would be possible to have a plurality of collection points and a plurality of discharge conduits for each one collection header or for several collection headers, such as the collection header 24, if desired. For example, a Yankee dryer according to a further aspect of the invention (not shown) could have two condensate evacuation systems formed in essentially in mirror image configurations, each discharging to a different end of the cylindrical drum. Also, redundant collection systems having two different collection points could be arranged to discharge collected condensate to the same side of the cylindrical drum.

Where used, the term “at least one” explicitly contemplates two or more of the referenced item.

While the present has been described in connection with what is considered the most practical and preferred embodiments, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A Yankee dryer having centrifugally assisted condensate collection, comprising:
a cylindrical drum having a circumferential wall, a first end wall, a second end wall, an axis of rotation, radial distances originating at the axis of rotation, a mainstay disposed to position the cylindrical drum relative to an environmental support; and
at least one condensate disposal system comprising a collection header extending in a direction parallel to the axis of rotation, a plurality of pickup straws projecting laterally from and disposed in fluid communication with the collection header and comprising a pickup opening which opens to the interior of the cylindrical drum and a discharge opening which opens to the interior of the collection header, and a disposal riser conduit disposed in fluid communication with the collection header and arranged to extend to the axis of rotation and along the axis of rotation to the first end wall and from the first end wall to the exterior of the cylindrical drum, wherein
the pickup opening of each one of the pickup straws is located at a first radius from the axis of rotation and the discharge opening of each one of the pickup straws is located at a second radius from the axis of rotation which said second radius is greater in magnitude than the first radius.

2. The Yankee dryer of claim 1, wherein each one of the pickup straws has a center line and the disposal riser conduit has a center line forming an included angle with the center line of any one of the straws, and the included angle between the center line of any one straw and the center line of the disposal riser conduit lies within a range of about eighty degrees and about ninety degrees.

3. The Yankee dryer of claim 1, wherein the collection header has opposed ends, and the outer wall of the collection header inclines continuously along its length relative to the axis of rotation of the cylindrical drum such that the radial distance from the axis of rotation to the inner surface of the outer wall of the collection header is greatest at the location of the pickup opening of the disposal riser conduit and is smallest at the opposed ends of the collection header.

4. The Yankee dryer of claim 1, wherein the outer wall of the collection header and the circumferential wall of the cylindrical drum each have length which is oriented parallel to the length of the other, and wherein the outer wall of the collection header and the circumferential wall of the cylindrical drum form an included angle therebetween along the lengths of the collection header and of the circumferential wall, wherein the included angle is between 0.1 degree and about ten degrees.

5. The Yankee dryer of claim 1, wherein the collection header abuts the circumferential wall of the cylindrical drum.

6. The Yankee dryer of claim 1, wherein the at least one condensate disposal system comprises at least two condensate disposal systems.

7. The Yankee dryer of claim 6, wherein the disposal riser conduit of one of the condensate disposal systems joins the disposal riser conduit of another one of the condensate disposal systems at the axis of rotation to form a singular conduit extending along the axis of rotation.

8. A Yankee dryer having centrifugally assisted condensate collection, comprising:
a cylindrical drum having a circumferential wall, a first end wall, a second end wall, an axis of rotation, radial distances originating at the axis of rotation, a mainstay disposed to position the cylindrical drum relative to an environmental support; and
at least one condensate disposal system comprising a collection header extending in a direction parallel to the axis of rotation, a plurality of pickup straws projecting laterally from and disposed in fluid communication with the collection header, each one of the pickup straws having a pickup opening which opens to the interior of the cylindrical drum and a discharge opening which opens to the interior of the collection header, and a disposal riser conduit disposed in fluid communication with the collection header and arranged to extend to the axis of rotation, along the axis of rotation to the first end wall, and from the first end wall to the exterior of the cylindrical drum, wherein the disposal riser conduit has a pickup opening disposed in fluid communication with the collection header and a discharge opening, wherein
the collection header has an outer wall facing the circumferential wall of the cylindrical drum arranged such that the inner surface of the outer wall of the collection header has a radial distance from the axis of rotation of the cylindrical drum which is greater at the pickup opening of the riser conduit than at any other point along the length of the collection header.

9. The Yankee dryer according to claim 8, wherein the collection header has opposed ends, and the outer wall of the collection header inclines continuously along its length relative to the axis of rotation of the cylindrical drum such that the radial distance from the axis of rotation to the inner surface of the outer wall of the collection header is greatest at the location of the pickup opening of the riser conduit and is smallest at the opposed ends of the collection header.

10. The Yankee dryer of claim 9, wherein the outer wall of the collection header and the circumferential wall of the cylindrical drum each have length which is oriented parallel to the length of the other, and wherein the outer wall of the collection header and the circumferential wall of the cylindrical drum form an included angle therebetween along the lengths of the collection header and of the circumferential wall, wherein the included angle is between 0.1 degree and about ten degrees.

11. The Yankee dryer of claim 8, wherein the collection header abuts the circumferential wall of the cylindrical drum.

12. The Yankee dryer of claim 8, wherein the at least one condensate disposal system comprises at least two condensate disposal systems.

13. The Yankee dryer of claim 12, wherein the riser conduit of one of the condensate disposal systems joins the riser conduit of another one of the condensate disposal systems at the axis of rotation to form a singular conduit extending along the axis of rotation.

14. A method of equipping different types or models of Yankee dryers, comprising the steps of:
fabricating condensate disposal system modules to only one design;
installing at least two of the identical condensate disposal system modules in a particular Yankee dryer;
installing other ones of the identical condensate disposal system modules in a different Yankee dryer; and
installing identical condensate disposal system modules in any one Yankee dryer in proportion to the condensate production rate of the one Yankee dryer.
